(19) United States
(12) Patent Application Publication
(10) Pub. No.: US 2007/0075824 A1
(43) Pub. Date: Apr. 5, 2007

(54) Advanced thick film potentiometers

(75) Inventors: Danial L. Kosht, Gaylord, MI (US); Reza Oboodi, Morris Plains, NJ (US); James Piascik, Randolph, NJ (US); Joseph M. Walling, Boyne City, MI (US)

Correspondence Address: Kris T. Fredrick;Honeywell International, Inc., 101 Columbia Rd., P.O. Box 2245, Morristown, NJ, 07962, US

(73) Assignee: Honeywell International Inc.

(21) Appl. No.: 11/243,261

(22) Filed: Oct. 3, 2005

(51) Int. Cl. H01C 10/32

(52) U.S. Cl. 338/162

(57) ABSTRACT

A potentiometer apparatus and method include a plurality of potentiometer components etched onto a substrate. A conductor layer can be printed and fired upon the substrate and over the array of potentiometer components. Thereafter, a thick film layer can be configured upon the substrate. Each potentiometer component can then be laser trimmed from among the plurality of potentiometer components in order to obtain a proper resistance and linearity for each potentiometer component thereof, thereby forming a potentiometer apparatus from each potentiometer among the potentiometer components. The resulting potentiometer apparatus thus constitutes an advanced thick-film (ATF) potentiometer.

### TECHNICAL FIELD

Embodiments are generally related to potentiometer devices. Embodiments are also related to Advanced Thick-Film (ATF) materials and ATF devices.

### BACKGROUND

Potentiometers are utilized in a variety of commercial, industrial and aerospace applications. A potentiometer is a device that provides an adjustable electric potential. Essentially, this instrument balances the unknown voltage against a known, adjustable voltage. Potentiometers are frequently utilized to convert rotary and linear motion into an electrical signal. A typical potentiometer can be implemented in the context of a voltage divider utilized for measuring, rotary angles or linear motion. Usually, a potentiometer or “pot” is utilized as an inexpensive position sensor or feedback device in motion control systems.

One type of potentiometer that has been implemented in various commercial, industrial and aerospace applications is the thick film potentiometer, which is based on “thick film” fabrication technology. A thick-film potentiometer typically includes a support substrate, particularly a plastic substrate, onto which there is applied at least one resistance path of resistance composition which is contacted via conductive lines on the support substrate at least at its ends and possibly at fixed tapping points arranged between its ends, and having a wiper path which extends along the resistance path and over which a wiper is swingable. In such known rotary resistors or potentiometers of thick-film type, the resistance path is provided also in the region of the wiper path above the contact paths. The wiper accordingly contacts on the resistance composition over the entire region of the wiper path.

Current thick film potentiometers are fabricated onto plastic or laminate substrates that limit the power dissipation, and the upper operating temperature as well as the form factors thereof. Such devices can also be costly to fabricate, particularly in low volumes. It is therefore believed that a solution to such limitations involves the design and implementation of an improved ATF potentiometer device that can be produced in low volumes and which provides for improved power, dissipation and high temperature performance. An ATF potentiometer can also be implemented on non-flat surfaces. Such an improved potentiometer is described in greater detail herein.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for an improved potentiometer.

It is another aspect of the present invention to provide for an advanced thick-film (ATF) potentiometer.

It is a further aspect of the present invention to provide for an advanced thick-film (ATF) potentiometer fabricated from an array of ATF components configured upon a substrate material, such as, for example, metal or alumina.

The aforementioned aspects of the invention and other objectives and advantages can now be achieved as described herein. A potentiometer apparatus and method are disclosed. In general, a plurality of potentiometer components can be etched onto a substrate. The substrate can be then electrically insulated by depositing and firing a thin layer of ceramic thereon. Next a conductor layer can be printed and fired upon the substrate and over the array of potentiometer components. Thereafter, a thick film layer can be configured upon the substrate. Each potentiometer component can then be trimmed from among the plurality of potentiometer components in order to obtain a proper resistance and linearity for each potentiometer component thereof, thereby forming a potentiometer apparatus from each potentiometer among the plurality of potentiometer component. The resulting potentiometer apparatus thus constitutes an advanced thick-film (ATF) potentiometer. The substrate can be provided as a metal substrate, such as, for example, a FeCr alloy. Alternatively an insulating substrate can also be used as, for example, an alumina substrate that would not require any additional insulation layer between the substrate & conductive or resistive layers.

The plurality of potentiometer components can be implemented as an array of potentiometer components, wherein the array of the potentiometer components is etched into a thin sheet of the substrate. Each potentiometer component of the array of potentiometer components may include disc and/or rectangular shapes. Such an array of potentiometer components may be provided the form of a rotary array or a linear array, depending upon design considerations.

A plurality of potentiometers can also be fabricated onto a non-flat surface, such as a long shaft. The processing and materials for such a configuration are similar to the processes described above. Leveraging the insulating and conductive layering of the ATF potentiometer construction, electronic components can be placed onto the resulting ATF potentiometer device. Such electronic components can perform functions such as signal conditioning or output digitization, while also allowing for all linearity corrections to be accomplished electronically.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a top view of one possible implementation of an ATF potentiometer component and a plurality of potentiometer components thereof formed in an array, in accordance with a preferred embodiment;

FIG. 2 illustrates a side view of one possible implementation of an ATF potentiometer and an application assembly, which can be implemented in accordance with one embodiment;

FIG. 3 illustrates a block diagram of an electrical circuit, which can be utilized for implementing a potentiometer apparatus, in accordance with a preferred embodiment;

FIG. 4 illustrates a pictorial diagram of a potentiometer apparatus that can be integrated with an irregular shaped assembly such as an axle, shaft or other rotatable component, in accordance with an alternative embodiment;

FIG. 5 illustrates an array composed of four printed potentiometer components, in accordance with an alternative embodiment;

FIG. 6 illustrates a perspective view of a single potentiometer element of an array, in accordance with a preferred embodiment;

FIG. 7 illustrates a top view of a single potentiometer element of an array, in accordance with a preferred embodiment; and

FIG. 8 illustrates a high-level flow chart of operations depicting logical operational steps that may be followed in order to implement an ATF potentiometer apparatus, in accordance with one embodiment.

### DETAILED DESCRIPTION

The particular values and configurations discussed in these non-limiting examples can be varied and are cited merely to illustrate at least one embodiment and are not intended to limit the scope of the invention.

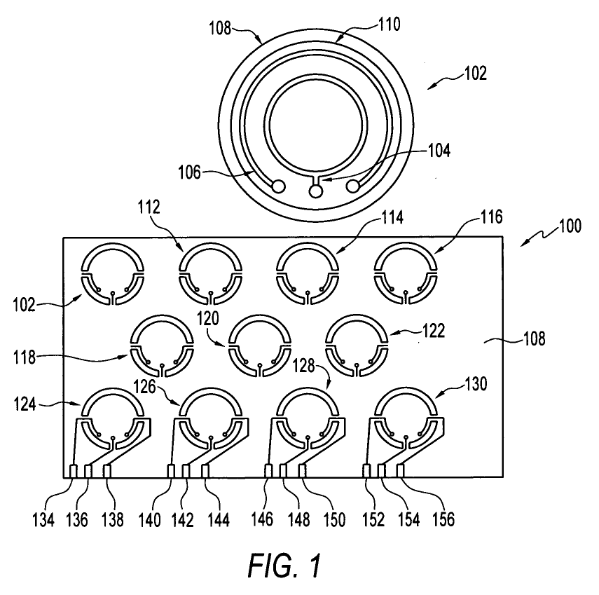

FIG. 1 illustrates a top view of an ATF potentiometer component 102 and a plurality of potentiometer components thereof formed in an array 100, in accordance with a preferred embodiment. The ATF potentiometer array 100 depicted in FIG. 1 includes a plurality ATF potentiometer components 102, 112, 114, 116, 118, 120, 122, 124, 126, 128, and 130. Each of the ATF potentiometer components 102, 112, 114, 116, 118, 120, 122, 124, 126, 128, and 130 are identical to one another and thus include the same general form as ATF potentiometer component 102, which is shown in detail in FIG. 1.

The ATF potentiometer component 102 includes a substrate 108 and an insulating layer 110. A thick film trace 106 can be configured on the insulating layer 110 and surrounding a circular conductive path 104. The substrate 108 can be provided as a metal substrate, such as, for example, an FeCr alloy. Substrate 108 may also be provided as an alumina substrate, depending upon design considerations. Dual concentric traces 106 and 104 can be printed on insulator 110 in order to create a potentiometer apparatus thereof. The outer trace 106 can function as, for example, a thick film resistor, while the inner trace 104 can be implemented from a conductive material such as, for example, gold or thick film as well.

The array 100 of potentiometer components 102, 112, 114, 116, 118, 120, 122, 124, 126, 128, and 130 can be etched onto substrate 108. Next a conductor layer (e.g., to form layer or trace 104) can be printed and fired upon the substrate 108 and over the array 100 of potentiometer components 102, 112, 114, 116, 118, 120, 122, 124, 126, 128, and 130. Thereafter, a thick film layer (e.g., to form thick film trace 106) can be configured upon the substrate 108.

Each potentiometer component 102, 112, 114, 116, 118, 120, 122, 124, 126, 128, and 130 can then be trimmed from among array 100 of potentiometer components 102, 112, 114, 116, 118, 120, 122, 124, 126, 128, and 130 in order to obtain the proper resistance and linearity for each potentiometer component 102, 112, 114, 116, 118, 120, 122, 124, 126, 128, and 130 thereof, thereby forming a potentiometer apparatus from each potentiometer component of the array 100. The resulting potentiometer apparatus (e.g., such as ATF potentiometer apparatus or component 102) thus constitutes an advanced thick-film (ATF) potentiometer.

The resulting ATF potentiometer apparatus 102, for example, can be fabricated by etching the array 100 of round disks 102, 112, 114, 116, 118, 120, 122, 124, 126, 128, and 130 into a thin sheet of the substrate 108 material. If necessary, an insulating ceramic layer 110 can be coated and fired onto substrate 108. Then, a conductive layer can be printed and fired, followed by a thick film layer. The elements 102, 112, 114, 116, 118, 120, 122, 124, 126, 128, and 130 are then trimmed while still in the array 100 in order to obtain the proper resistance and linearity. Alternatively, the elements 102, 112, 114, 116, 118, 120, 122, 124, 126, 128, and 130 can be formed into linear array configurations instead of rotary arrays. Linearity trimming thus can be accomplished while in the array 100 using printed I/O pads 134, 136, 138, 140, 142, 144, 146, 148, 150, 152, 154, and 156 on the array 100.

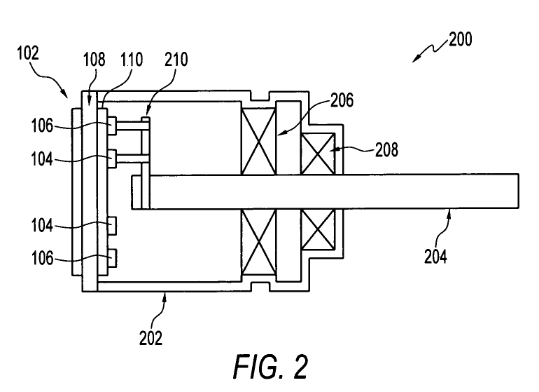

FIG. 2 illustrates a side view of an ATF potentiometer apparatus 102 and an application assembly 200, which can be implemented in accordance with one embodiment. Assembly 200 generally includes an input shaft 204 that is held in place by a dual bar wiper 210 partially within a housing 202. Housing 202 surrounds and maintains bearings 206, 208. ATF potentiometer apparatus 102 connects to the dual bar wiper 210 via the thick film trace 106 and the conductive layer or trace 104. ATF potentiometer apparatus further includes substrate 108 and the dielectric layer or component 110.

Note that in FIGS. 1-2, identical or similar parts or elements are generally indicated by identical reference numerals. In general, the ATF potentiometer sensor or apparatus 102 can be welded into housing 202 in order to eliminate the need for separate detection components. The configuration of FIG. 1 can offer a higher power rating versus conventional plastic or laminate-based potentiometers. Assembly 100 can be implemented, for example, in the context of automotive applications, such as, for example, where input shaft 204 constitutes a drive shaft, a crank shaft, a cam shaft, and so forth.

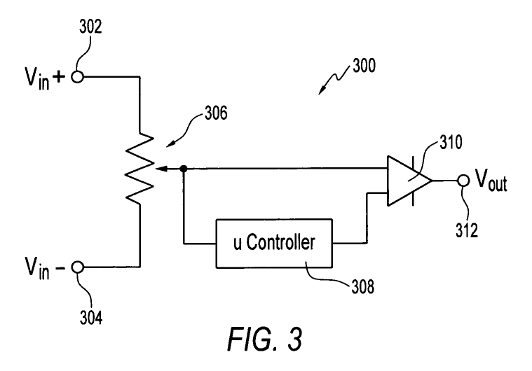

FIG. 3 illustrates a schematic diagram of an electrical circuit 300, which can be utilized for implementing a potentiometer apparatus, in accordance with a preferred embodiment. Circuit 300 generally includes a microcontroller 308 that is coupled between a variable resistor or potentiometer 306 and an amplifier 310 that produces an output voltage 312. The potentiometer 306 can be implemented via, for example, ATF potentiometer apparatus 102 or any of the other formed potentiometers 112, 114, 116, 118, 120, 122, 124, 126, 128, and 130 described earlier. Potentiometer 306 is thus disposed between a positive voltage terminal 302 and a negative voltage terminal 304.

Circuit 300 can function in the context of a potentiometer encoder. In such a configuration, alumina may be utilized for the backing material or substrate 108 described earlier. Circuit 300 can be provided as a circuit layout fabricated onto the reverse side of a potentiometer, such as, for example, any one of the resulting potentiometers 102, 112, 114, 116, 118, 120, 122, 124, 126, 128, and 130. The microcontroller 308 can be incorporated into circuit 300 to enable the creation of a high accuracy potentiometer (e.g., approximately 0.05%). A signal-conditioning Application Specific Integrated Circuit (ASIC) can also be utilized in place of or in addition to microcontroller 308 in the context of circuit 300 in order to result in a high accuracy potentiometer. Another option involves the incorporation of an electrical bus system to create a low cost digital position sensor.

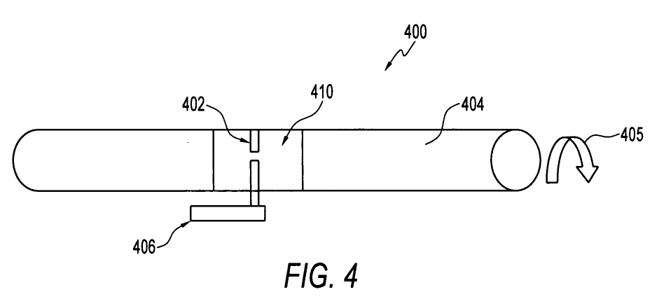

FIG. 4 illustrates a pictorial diagram of a potentiometer apparatus 402 that can be integrated with an irregular shaped assembly 404 such as an axle, shaft or other rotatable component, in accordance with an alternative embodiment. In the configuration illustrated in FIG. 4, the potentiometer apparatus 402 is printed directly onto the assembly 404. The potentiometer apparatus 402 is surrounded by or integrated with a dielectric layer or component 410. The potentiometer apparatus 402 is also connected directly to a single bar wiper 406. Note that the potentiometer apparatus 402 is analogous to one or more of the ATF potentiometer components or devices 102, 112, 114, 116, 118, 120, 122, 124, 126, 128, and 130 described earlier. Similarly, dielectric component or layer 410 is similar to dielectric layer 110 depicted in FIGS. 1-2. The configuration depicted in FIG. 4 generally eliminates the need for a secondary potentiometer element to be mounted in large assemblies.

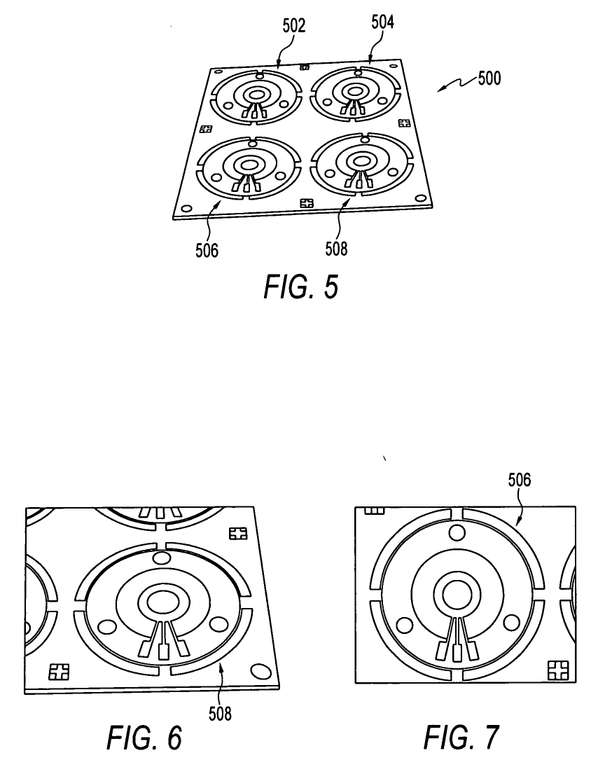

FIG. 5 illustrates an array 500 composed of four printed potentiometer components or devices 502, 504, 506 and 508, in accordance with an alternative embodiment. Note that each of the potentiometer components or devices 502, 504, 506 and 508 are analogous or similar to the ATF potentiometer components or devices 102, 112, 114, 116, 118, 120, 122, 124, 126, 128, and 130 described earlier. Note that in FIGS. 5-6, identical or similar parts or elements are generally indicated by identical reference numerals.

FIG. 6 illustrates a perspective view of a single potentiometer element 508 of the array 500, in accordance with a preferred embodiment. Likewise, FIG. 7 illustrates a top view of a single potentiometer element 506 of the array 500, in accordance with a preferred embodiment.

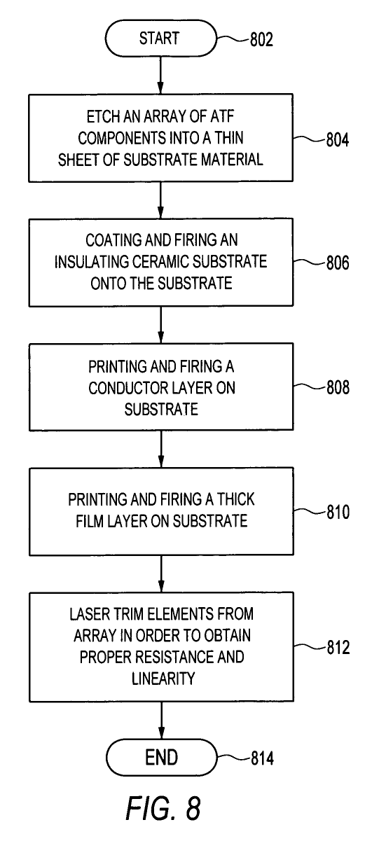

FIG. 8 illustrates a high-level flow chart 800 of operations depicting logical operational steps that may be followed in order to implement an ATF potentiometer apparatus, in accordance with one embodiment. The process can be initiated as indicated at block 802. Thereafter, as depicted at block 802, an ATF potentiometer can be fabricated by etching the array 100 of components or disks 102, 112, 114, 116, 118, 120, 122, 124, 126, 128, and 130 onto the thin sheet of material forming substrate 108. If necessary, as indicated thereafter at block 806, an insulating ceramic layer can be coated and fired onto substrate 108. Next, a conductor layer can be printed and fired onto substrate 108 as depicted at block 808, followed by a thick film layer, as indicated at block 810. The 102, 112, 114, 116, 118, 120, 122, 124, 126, 128, and 130 can then be laser trimmed while still in the array 100 in order to obtain the proper resistance and linearity as described at block 812. Alternatively, the elements 102, 112, 114, 116, 118, 120, 122, 124, 126, 128, and 130 can be formed into linear arrays instead of rotary arrays. The process can then terminate, as depicted at block 814.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of forming a potentiometer apparatus, comprising:
etching a plurality of potentiometer components onto a substrate;
printing and firing a conductor layer upon said substrate and over said array of potentiometer components;
thereafter configuring a thick film layer upon said substrate; and
thereafter trimming each potentiometer component from among said plurality of potentiometer components in order to obtain a proper resistance and linearity for each potentiometer component thereof, thereby forming a potentiometer apparatus from each potentiometer among said plurality of potentiometer component.

2. The method of claim 1 wherein said potentiometer apparatus comprises an advanced thick-film (ATF) potentiometer.

3. The method of claim 1 further comprising initially providing said substrate as a metal substrate.

4. The method of claim 3 wherein said metal substrate comprises at least one of the following: FeCr or Haynes 214 alloys.

5. The method of claim 3 further comprising electrically insulating said metal substrate with a dielectric layer.

6. The method of claim 5 wherein said dielectric layer comprises a thin layer of ceramic.

7. The method of claim 1 further comprising initially providing said substrate as an alumina substrate.

8. The method of claim 1 further comprising providing said plurality of potentiometer components as an array of potentiometer components, wherein said array of said potentiometer components is etched into a thin sheet of said substrate.

9. The method of claim 8 wherein each potentiometer meter component of said array of potentiometer components comprises a disc shape.

10. The method of claim 8 wherein said array of potentiometer components comprises a rotary array.

11. The method of claim 8 wherein said array of potentiometer components comprises a linear array.

12. The method of claim 1 further comprising configuring and location said potentiometer apparatus directly onto an irregular shaped assembly.

13. A potentiometer apparatus, comprising:
a plurality of potentiometer components etched onto a substrate;
a conductive layer printed and fired upon said substrate and over said plurality of potentiometer components; and
a thick film layer configured upon said substrate, wherein a potentiometer component is trimmed from among said plurality of potentiometer components in order to obtain a proper resistance and linearity for each potentiometer component thereof, thereby forming a potentiometer apparatus from each potentiometer component among said plurality of potentiometer component.

14. The apparatus of claim 10 wherein said potentiometer apparatus comprises an advanced thick-film (ATF) potentiometer.

15. The apparatus of claim 10 further comprising initially providing said substrate as a metal substrate.

16. The apparatus of claim 12 further comprising providing a dielectric layer for electrically insulating said metal substrate

17. The apparatus of claim 10 further comprising initially providing said substrate as an alumina substrate.

18. The apparatus of claim 10 further comprising providing said plurality of potentiometer components as an array of potentiometer components, wherein said array of said potentiometer components is etched into a thin sheet of said substrate.

19. The apparatus of claim 10 wherein said substrate comprises an alumina substrate.

20. A potentiometer apparatus, comprising:
an array of ATF potentiometer components etched onto a thin sheet of a substrate;
a conductive layer printed and fired upon said substrate and over said array of ATF potentiometer components; and
a thick film layer configured upon said substrate, wherein an ATF potentiometer component is laser trimmed from said array of ATF potentiometer components in order to obtain a proper resistance and linearity for each ATF potentiometer component thereof, thereby forming an ATF potentiometer apparatus from each ATF potentiometer component of said array of ATF potentiometer component.

21. The apparatus of claim 20 wherein said array of potentiometer components comprises a rotary array or a linear array

22. The apparatus of claim 20 wherein said substrate comprises a metal substrate.
